(19) United States
(12) Patent Application Publication
(10) Pub. No.: US 2009/0167634 A1
(43) Pub. Date: Jul. 2, 2009

(54) SYSTEMS HAVING DETACHABLE TWIN DISPLAY MONITORS

(75) Inventor: Tai-Sheng (Andrew) Han, Fullerton, CA (US)

Correspondence Address: IPxLAW Group LLP, 95 South Market Street, Suite 570, San Jose, CA, 95113, US

(73) Assignee: EVGA Corporation, Brea, CA (US)

(21) Appl. No.: 11/966,449

(22) Filed: Dec. 28, 2007

(51) Int. Cl. G09G 5/00; G06F 1/16

(52) U.S. Cl. 345/1.3; 345/1.1

(57) ABSTRACT

Systems for displaying a plurality of images. A system includes: a hollow post having a recessed portion; and a pair of pivot arms that include mounting protrusions pivotally mounted in the recessed portion. Each pivot arm is adapted to pivot about a first axis parallel to a longitudinal axis of the hollow post. The system also includes a pair of mounting assemblies respectively affixed to the pivot arms and a pair of monitors respectively secured to the mounting assemblies. Each mounting assembly is adapted to allow one of the monitors to rotate relative to one of the pivot arms about a second axis substantially perpendicular to the first axis and includes a first signal connector. Each monitor frame includes two second signal connectors configured to respectively engage the first signal connector at portrait and landscape orientations thereof relative to the post.

### CROSS REFERENCE TO RELATED APPLICATIONS

This application is related to the copending U.S. patent application Ser. No. ______, entitled “Systems having twin display monitors” by Han, filed on Dec. 28, 2007, which is incorporated by reference in its entirety.

### BACKGROUND OF THE INVENTION

The present invention generally relates to electronic display systems and, more particularly, to a novel display system having detachable twin display monitors.

With the advance of computer technology, a computer allows the user to run multiple application programs simultaneously and display the graphic user interfaces (GUI) of the programs on a display screen. In general, a larger display area may provide enhanced flexibility in arranging GUIs and other images on the screen. Thus, various approaches to increase the display area have been developed. For instance, U.S. Pat. No. 6,222,507 to Gouko discloses a personal computer having multiple display panels to increase the total display area. In the Gouko '507 patent, the computer includes a primary display panel and two or more secondary display panels that are disposed on opposite sides of, or above the primary panel and can be slid to be contained into the primary display panel. As such, the secondary display panels are smaller than the primary display panel, which may limit the utility of the multiple panels. For example, two electronic gamers playing the same game with each other may need two sets of identical operational environments, such as identical display panels having the same pixel resolution and screen size, identical input controls, speakers, etc., so that the gamers can play the game under the equal condition. Due to the difference in the size between the primary and second display panels, the system disclosed in the Gouko '507 patent may not be suitable for such applications. Also, as the personal computer is designed for one user, the second user watching the secondary display panel may not be able to have the same access to the computer as the primary user, much less the control over the images on the second display panel. For another example, a manager interviewing an employee may need to turn the manager's computer screen into a side way so that they can view the screen simultaneously or even ask the employee to move behind him so that the employee can watch the monitor screen over the manager's shoulder.

In addition, a typical monitor is positioned in landscape mode. If a user wants to rotate the monitor into portrait mode, the user needs a monitor post having a rotational mechanism to which the monitor is mounted. However, in general, such a rotational mechanism does not allow the user to rotate the monitor to a viewer sitting on opposite side of the post, nor does it accommodate more than one monitor. Thus, there is a strong need for a computer system that includes two identical display panels and allows two users to view face to face the display panels in either portrait or landscape orientation.

### SUMMARY OF THE INVENTION

In one aspect of the present invention, a system for displaying a plurality of images includes: a hollow post that is adapted for connection to a support means and has a recessed portion; and a pair of pivot arms that include mounting protrusions pivotally mounted in the recessed portion. Each of the pivot arms is adapted to pivot about a first axis parallel to a longitudinal axis of the hollow post. The system also includes a pair of mounting assemblies respectively affixed to the pivot arms and a pair of monitors respectively secured to the mounting assemblies. Each mounting assembly is adapted to allow one of the monitors to rotate relative to one of the pivot arms about a second axis substantially perpendicular to the first axis and includes a first signal connector. Each monitor frame includes two second signal connectors configured to respectively engage the first signal connector at portrait and landscape orientations thereof relative to the post.

In another aspect of the present invention, a system for displaying a plurality of images includes: a hollow post adapted for connection to a support means; a pair of mounting assemblies affixed to the hollow post; and a pair of monitors respectively secured to the mounting assemblies. Each mounting assembly is adapted to allow a monitor to pivot about a first axis substantially parallel to the longitudinal axis of the hollow post and to rotate about a second axis substantially perpendicular to the first axis. Each mounting assembly includes a first signal connector, while each monitor frame includes two second signal connectors configured to respectively engage the first signal connector at portrait and landscape orientations thereof relative to the post.

### BRIEF DESCRIPTION OF THE DRAWINGS

FIG. 1 shows a perspective view of a twin view system in accordance with one embodiment of the present invention;

FIG. 2 shows a schematic exploded perspective view of a post of the system in FIG. 1;

FIG. 3A shows a schematic perspective view of a pivot arm and a monitor of the system in FIG. 1;

FIG. 3B shows another schematic perspective view of the pivot arm in FIG. 3A;

FIG. 4 shows a schematic cross sectional view of the pivot arm in FIG. 3B, taken along the line 4-4;

FIG. 5A shows a schematic side cross sectional view of the region A in FIG. 3A;

FIG. 5B shows a schematic perspective view of the mounting assembly in FIG. 5A;

FIG. 5C shows an enlarged view of the portion AA in FIG. 5A;

FIG. 6 is a broken bottom, left side perspective view of one of the monitors in FIG. 1;

FIG. 7 shows a schematic perspective view of the system of FIG. 1 with the monitors arranged in portrait orientation;

FIG. 8 is a perspective view of an embodiment of a base of a type that might be used in a twin view system in accordance with the present invention;

FIG. 9 shows a perspective view of a twin view system in accordance with another embodiment of the present invention;

FIG. 10A shows a schematic perspective view of a pivot arm and a monitor of the system in FIG. 9;

FIG. 10B shows another schematic perspective view of a pivot arm and a monitor in FIG. 9; and

FIG. 11 shows a perspective view of a twin view system in accordance with yet another embodiment of the present invention;

FIG. 12 shows a schematic cross sectional view of the region B in FIG. 11;

FIG. 13 shows a schematic perspective view of the mounting assembly in FIG. 12;

FIG. 14 is a broken partial cut away front view of an alternative embodiment of a twin view system in accordance with the present invention;

FIG. 15 is a perspective view of a mounting assembly in FIG. 14;

FIG. 16A is a broken partial cut away front view of another alternative embodiment of a twin view system in accordance with the present invention;

FIG. 16B is an exploded view of an embodiment of a hinge mechanism in the twin view system of FIG. 16A; and

FIG. 17 shows an embodiment of a computer of a type that might be employed in accordance with the present invention.

### DETAILED DESCRIPTION OF THE INVENTION

The following detailed description is of currently contemplated modes of carrying out the invention. The description is not to be taken in a limiting sense, but is presented merely for the purpose of illustrating the general principles of the invention, since the scope of the invention is best defined by the appended claims.

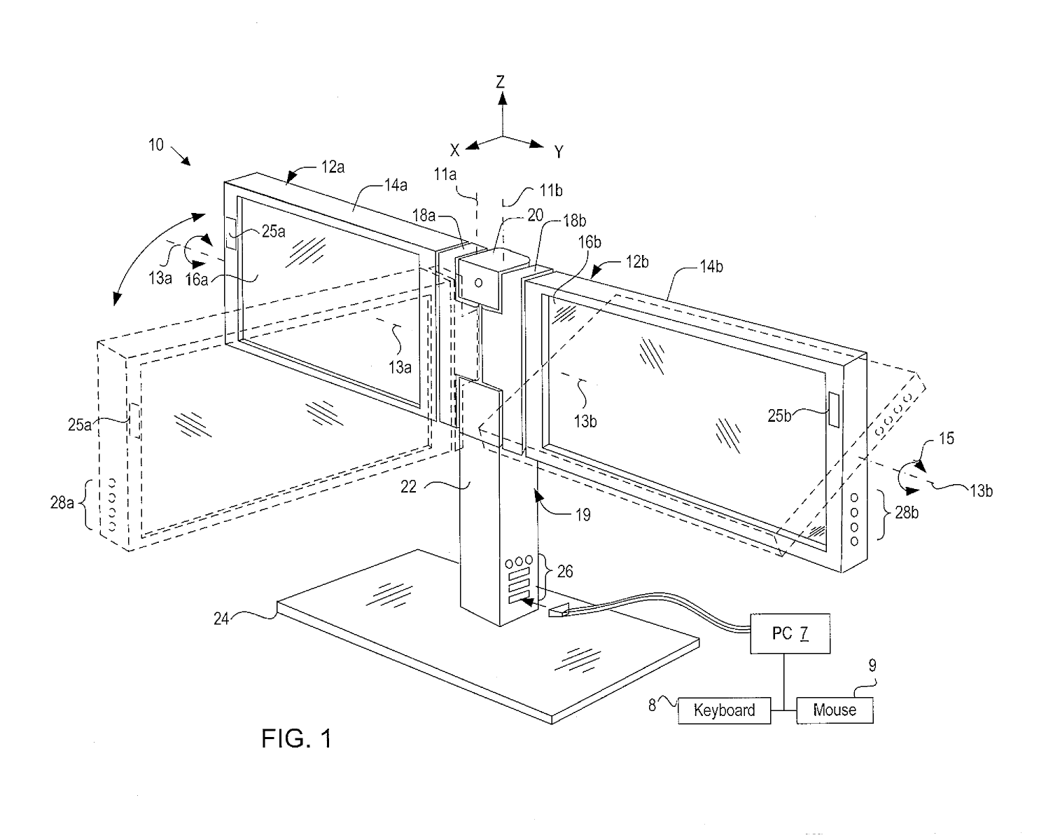

Referring now to FIG. 1, there is shown at 10 a perspective view of a twin view system in accordance with one embodiment of the present invention. As depicted, the system 10 may include a base 24; a post 19 secured to the base 24 and having an upper section 20, and a lower section 22 with input/output (or communication) ports 26; a pair of pivot arms 18a, 18b pivotally mounted to the upper section 20 and rotatable about axes 11a and 11b; and a pair of monitors 12a, 12b rotatably mounted to the pivot arms 18a, 18b and rotatable about axes 13a and 13b. Each monitor may include a display screen 16a (or 16b) and a frame 14a (or 14b) for supporting the display screen. In one exemplary embodiment, the frames 14a, 14b may provide mechanical support to the display screens 16a, 16b and include pertinent electrical connections extending from the input/output ports 26. In another exemplary embodiment, the frames 14a, 14b may each house independent computer, including thus one or more CPUs therein (not shown).

The monitors 12a, 12b as described have dual motion relative to the base 24, namely pivotal motion and rotational motion. The pivot arms 18a, 18b are rotatable relative to the post 19 about axes 11a, 11b parallel to the z-axis, allowing each of the monitors 12a, 12b to pivot within a preset angular interval, preferably about 90 degrees. However, as will be disclosed below, means may be provided for restricting the swing so as to avoid unintentional unbalance of the supporting assembly. (Hereinafter, the z-axis represents the axis substantially parallel to the longitudinal axis of the post 19.) However, notwithstanding the restrictions, the monitors 12a, 12b may be permitted to pivot into a closed position, allowing the display screens 16a, 16b to face each other, when it is desired to close the system 10 for protection, transport or the like. A suggested by the arrows 15, the monitors 12a, 12b may be also rotatable about the axes 13a, 13b within a preset angular interval, preferably 180 degrees, so that one or both of the screens can be viewed from the side opposite that depicted.

The user can operate the system 10 to use monitors 12a, 12b in a cloning (or mirroring) mode or in an extended mode. In the cloning mode, the monitors 12a, 12b display the same images. In the extended mode, one monitor may provide additional desk top area and each monitor may have different settings (resolution, color, refresh rate). In one exemplary operation of the system 10, one of the monitors, say 12b, may be rotated by 180 degrees and the display screens 16a, 16b may display the same images, i.e., the system 10 being in the cloning mode. In this operational mode, two users sitting on opposite sides of the assembly may view the same images and have the same level of access to the system 10 by use of multiple input devices coupled to the ports 26. For instance, the system 10 may allow two users to play the same electronic game with each other simultaneously using two identical joysticks (not shown) coupled to the ports 26. Note that in order to accommodate use of this mode, means must be provided to electronically invert the image displayed by the rotated monitor.

The monitors 12a, 12b may include control buttons 28a, 28b for setting screen display parameters, such as brightness, contrast, etc., and speakers 25a, 25b. Alternatively, only one set of control buttons, say 28a, may be used to set screen display parameters of both monitors 12a, 12b. It is noted that each monitor may have any suitable number of control buttons and speakers. Also, each monitor may include additional input/output ports, such as headphone, microphone, and jacks, etc., which are not shown in FIG. 1 for brevity.

The input/output ports 26 may receive plugs and/or connectors for various applications, such as power, video/audio data stream, and input devices (keyboard, mouse, etc.). For instance, the system 10 may play video/audio signals sent by a computer through ports 26 that may include a high-definition multimedia interface or other suitable wireless communication ports, such as IR or RF ports. The ports 26 may include a DMS input port for dual monitors. As discussed above, the system 10 may be accessed by two users simultaneously. In such a case, the ports 26 may accommodate connection of a pair of mouse plugs and/or a pair of keyboard plugs or other types of control device plugs, such as joysticks for electronic games. Moreover, the base 24 may house computer electronics.

The display screens 16a, 16b may employ, but are not limited to, liquid crystal display (LCD), light emitting diode (LED), vacuum fluorescent display (VFD) or other types of display panels, eliminating the bulkiness of conventional desktop cathode ray tube monitors. The generation of images for display on the screens 16a, 16b may arise from various sources. In one embodiment, the monitors 12a, 12b may include two separate internal or external computers (not shown in FIG. 1), and the processing units of the computers may be linked to respectively generate independent images to be displayed on the screens 16a, 16b. In another embodiment, the generation of images for display on the screens 16a, 16b may arise from one or more processing units of a computer that sends the generated image signals to the monitors through the ports 26. In this embodiment, one video card may be connected to the two monitors (dual head) or two separate video cards may be respectively connected to the two monitors.

The lower section 22 of the post 19 may be secured to the base 24 by suitable fastening mechanisms. In an alternative embodiment, the lower section 22 and base 24 may form an integral body. In FIG. 1, the base 24 is shown to have a generally rectangular cross sectional shape. However, it is should be apparent to those of ordinary skill that the base can have other suitable cross sectional shape, such as oval, circular, triangular, etc.

As the monitors 12a, 12b pivot and/or rotate relative to the post 19, the center of gravity of the system 10 may also shift relative to the base 24. The dimension and shape of the base may be determined such that the center of gravity of the system 10 can be located within the base 24 as the monitors 12a, 12b pivot and/or rotate within the pivotal and/or rotational extremities.

One or more of the input/output ports 26 may be connected to a computer, such as PC 7, via a connection wire. The computer 7 may include a keyboard 8 and mouse 9. The computer 7 may be connected to more than one keyboard and mouse to simultaneously accommodate more than one user.

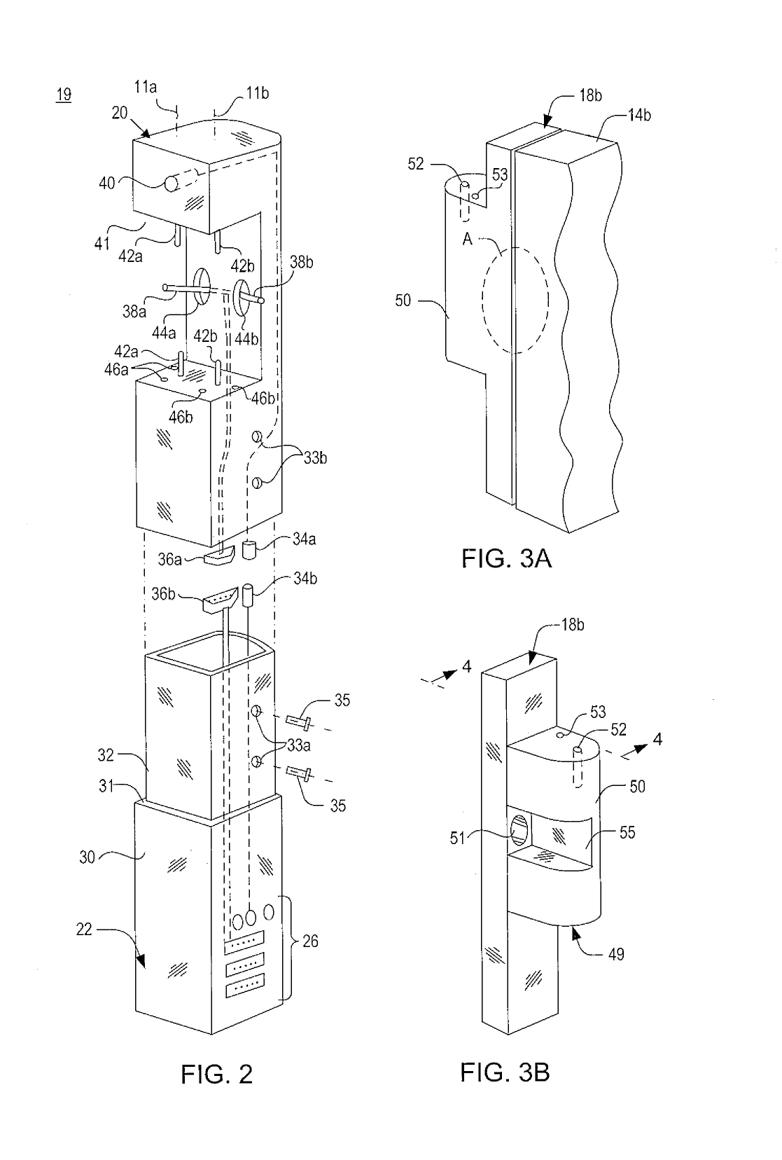

FIG. 2 shows an exploded perspective view of the post or stand assembly 19 in FIG. 1. FIG. 3A shows a schematic perspective view of the pivot arm 18b and frame 14b. FIG. 3B shows another schematic perspective view of the pivot arm 18b, seen from the backside thereof. As depicted, the post 19 may include an upper section 20 and a lower section 22 secured to the upper section by suitable fasters 35 passing through the holes 33a, 33b. The upper section 20 may be formed of an elongated hollow body having a recessed portion or slot 41 for receiving the pivot arms 18a, 18b (more specifically, the mounting protrusions 50 of the pivot arms) therein. The post 19 may be made of plastic or other suitable materials.

In FIG. 2, only two sets of holes 33a and 33b are shown. However, it should be apparent to those of ordinary skill that the post 19 may have more than two sets of holes arranged in the longitudinal direction of the post so that the user can adjust the location of the upper portion 20 relative to the lower section 22 along the longitudinal direction.

A camera 40 may be mounted in the wall of the upper section 20 and connected to a connector 34a which in turn is connected to one of the ports 26 via a plug 34b. In the cavity of the upper section 20 are cables 38a, 38b connected to one of the ports 26 via a connector 36a and a plug 36b. The cable 38b may pass through the hole 44b formed in the wall of the upper section 20 and through the hole 51 (FIG. 3B) formed in the pivot arms 18b to be connected to the frame 14b, and provide power and/or various electrical signals, such as video/audio and microphone (not shown in FIG. 2) signals, to the monitor 12b. The cable 38a may be connected to the monitor 12a in the similar manner. The connectors 36a and 36b are shown to be separate from the connectors 34a and 34b. However, an 80-pin connector may be used in place of the two separate connectors 34a and 36a.

The lower section 22 of the post 19 may include elongated hollow portions 30, 32. The upper portion 32 may be dimensioned to slip into the bottom portion of the upper section 20 so that the bottom end of the upper section 20 may engage and seat on the shoulder 31 in the lower section 22. The input/output ports 26 may be formed in the wall of the lower section 22. It should be apparent to those of ordinary skill that the ports 26 may include any suitable number of receptacles and plugs, such as 80 pin connectors, for communicating electrical signals therethrough.

The pivot arms 18a, 18b may be pivotally mounted to the upper section 20 by use of pivot rods 42a, 42b to be inserted into cavities 52 formed in the mounting protrusions 50 of the arms 18a, 18b. The pivot rods 42a and 42b may extend along the pivot axes 11a, 11b such that mounting protrusion 50 of the pivot arm 18b arranged in the slot 41 of the upper section 20 can pivot about the pivot axes. The mounting protrusion 50 may include one or more ball-nosed spring plungers 53 which act as detents to define the angular span of the pivot arm 18b. It should be apparent to those of ordinary skill that a ball-nosed spring plunger may be disposed in the bottom surface 49 of the mounting protrusion 50.

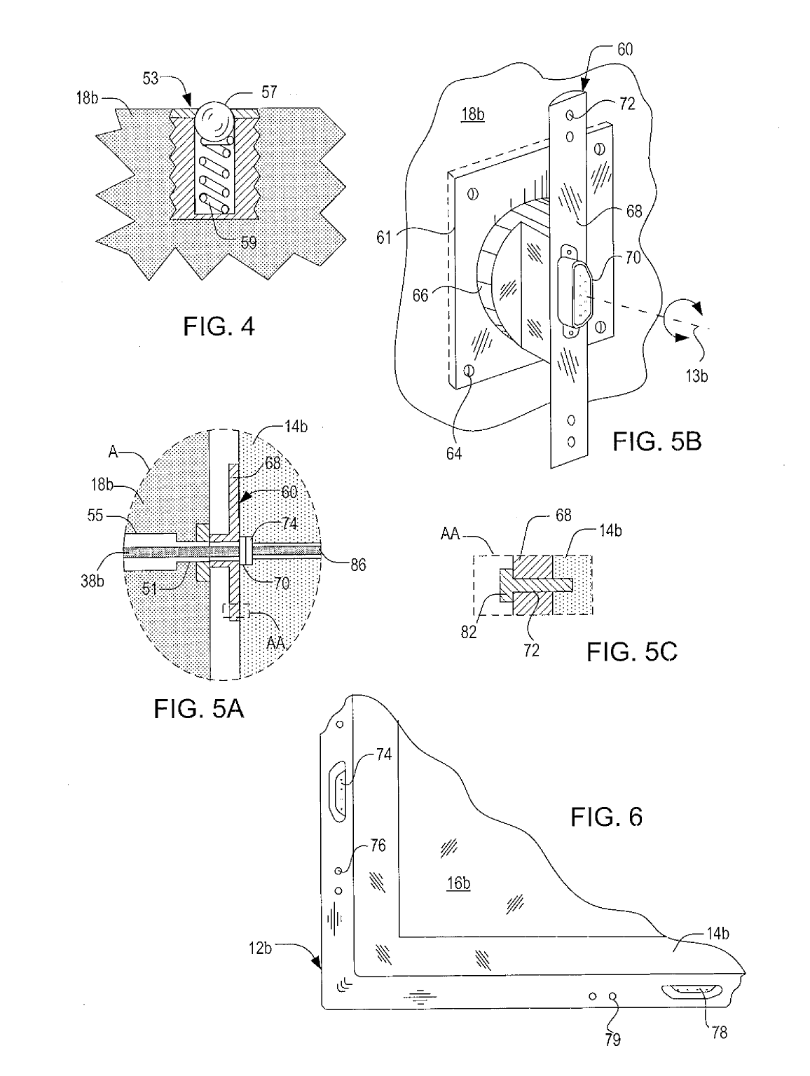

FIG. 4 shows a schematic cross sectional view of the pivot arm 18b, taken along the line 4-4 to illustrate the detailed structure of the ball-nosed spring plunger 53 secured in the arm 18b. As depicted, the plunger 53 may include a ball 57 that may roll on a surface of the upper section 20 before being clamped or locked down to mating cavities 46b (FIG. 2) by the compression spring 59. The locations of the mating cavities 46a, 46b may determine the angular spans of the pivot arms 18a, 18b relative to the post 19. Additional mating cavities may be formed in the upper section 20 along the path of the ball 57 so that the user can locate the pivot arms 18a, 18b at predetermined angular positions relative to the post 19.

It is noted that the mounting protrusion 50 may include a slot 55 through which the cable 38b passes, as depicted in FIG. 3B. FIG. 5A shows a schematic side cross sectional view of the region A in FIG. 3A. As depicted, the cable 38b passing through the hole 44b (shown in FIG. 2) formed in the upper section 20 may pass through the slot 55 and hole 51 formed in the arm 18b to a connector 70. The connector 70 may include any suitable type of connection mechanism, such as 80-pin male connector, and engage its counterpart 74, such as 80-pin female connector, formed in the frame 14b. The connector 74 may be connected to a cable 38b that can communicate electrical signals therethrough.

The frame 14b may be rotatably mounted to the pivot arm 18b via the mounting assembly 60, allowing the user to rotate the frame 14b along the axis 13b. FIG. 5B shows a schematic perspective view of the mounting assembly 60, wherein the frame 14b is not shown therein for brevity. As depicted, the mounting assembly 60 may include an assembly base (or, shortly base) 61 affixed to the pivot arm 18b by suitable fasteners 64 and a turret 66 rotatably coupled to the base 61. The mounting assembly 60 may also include an elongated bracket 68 having a flat surface affixed to the frame 14b by fasteners passing through the holes 72 formed in the bracket 68. The turret 66 may rotate relative to the pivot arm 18b, allowing the frame 14b to rotate about an axis 13b. As discussed above, the mounting assembly 60 includes a connector 70 affixed thereto. It is noted that the pivot arm 18a and monitor 12a have the similar structures as the pivot arm 18b and monitor 12b. As such, a detailed description of the pivot arm 18a and monitor 12a is not repeated in the present document.

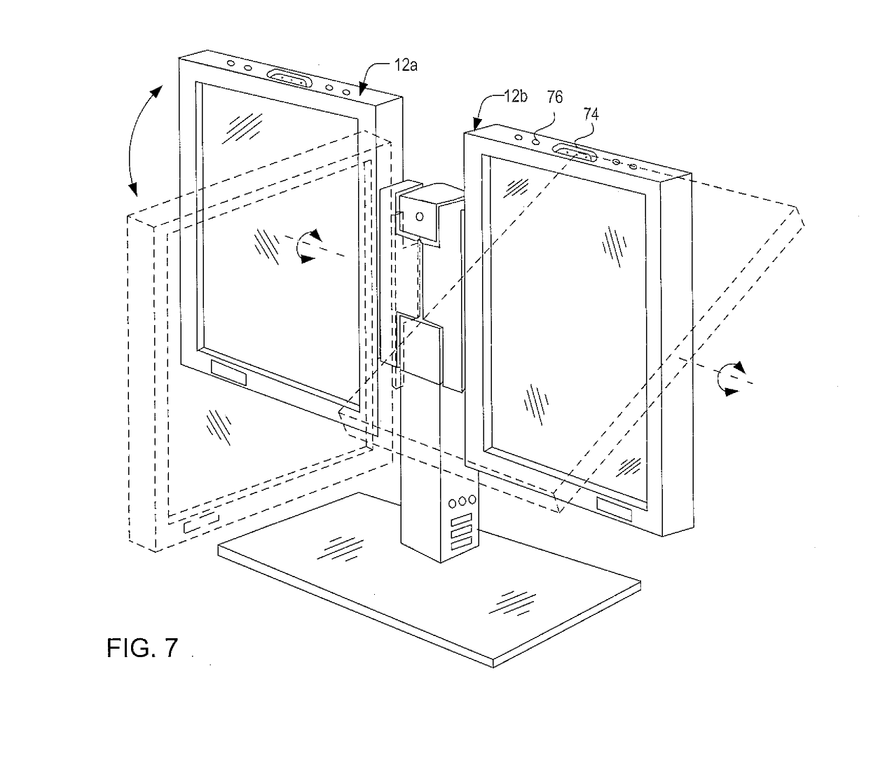

FIG. 5C shows an enlarged view of the portion AA in FIG. 5A. As depicted, a suitable fastener 82, such as a thumb screw, may be used to detachably secure the frame 14b (not shown in FIG. 5B) to the mounting assembly 60. FIG. 6 is a broken bottom, left side perspective view of one of the monitors in FIG. 1, illustrating another female connector 78 formed in the frame 14b and configured identical to the connector 74. The user can mount the monitor 12b to the pivot arm 18b in landscape mode by respectively engaging the fasteners 82 and male connector 70 into the threaded holes 76 and female connector 74. Likewise, the user can mount the monitor 12b to the pivot arm 18b in portrait mode by respectively engaging the fasteners 82 and male connector 70 into the threaded holes 79 and female connector 78. FIG. 7 shows a perspective view of the system 10 with both monitors 12a, 12b arranged in portrait mode.

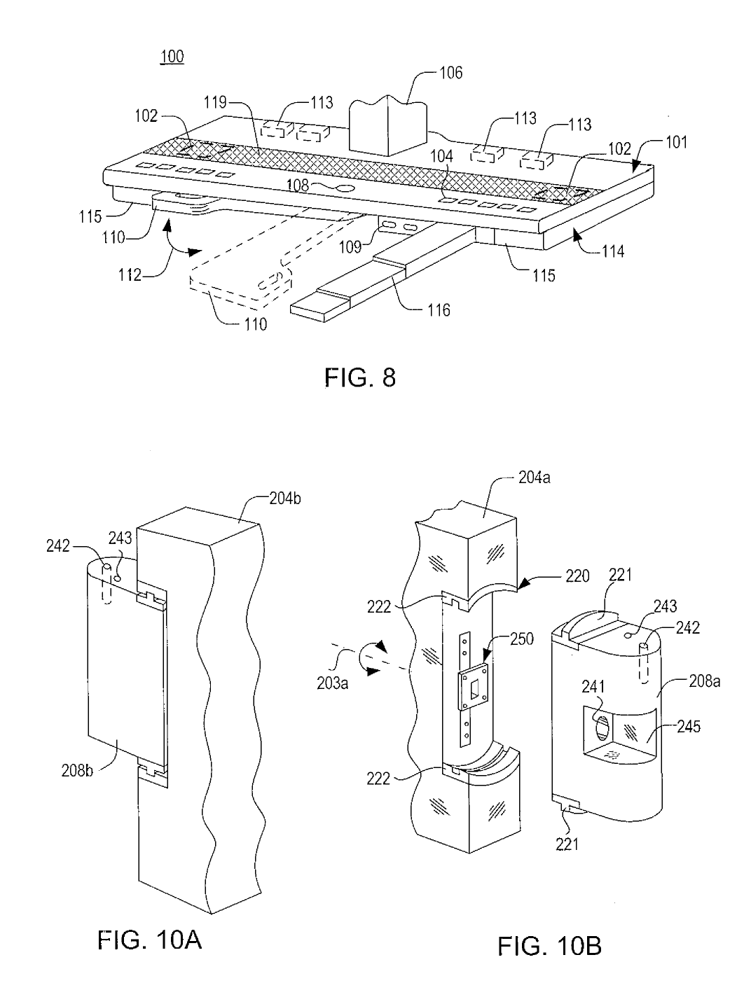

FIG. 8 is a perspective view of an embodiment of a base 100 of a type that might be used in a twin view system in accordance with the present invention. For simplicity, detailed description of the post and monitors, which are similar to those in FIG. 1, are not shown in FIG. 8. The base 100 may include one or more of various components: speakers 102; weights 115; one or more balance legs 110 and 116; and two sets of control buttons 104 for setting screen display parameters, such as brightness, contrast, etc.

As the monitors pivot and/or rotate relative to the base 100, the center of gravity of the twin view system may shift relative to the base 100. The shift may be maximum when both monitors 12a, 12b, for instance, are respectively rotated about the axes 11a and 11b by 90 degrees, thereby the screens are positioned to face each other. When the center of gravity is located near the edges of the base 100, the twin view system can be tipped over by an inadvertent force applied thereto. To increase the stability of the system, one or more balance legs 110 and 116 can be used. The pivoted balance leg 110 may be hinged at one end thereof by a knob 108 so that the leg can be disposed in the base 100 when not in use and swung out of the base as indicated by an arrow 112 when used. The dimension and shape of the balance leg 110 may be determined such that the center of gravity of the system can be located within the base 100 and leg 110 regardless of the monitors' position relative to the base. Alternatively, a telescopic balance leg 116 may be included in the base 100, wherein the leg 116 can be folded into the base when not in use. When extended, the telescopic balance leg 116 would have the similar functions as those of the pivoted balance leg 110.

In an alternative embodiment, the base 100 may include two pivoted balance legs that can rotate in opposite directions. In another alternative embodiment, the telescopic balance leg 116 may be used in place of the pivoted leg 110. It should be apparent to those of ordinary skill that other suitable combination of pivoted balance legs and/or telescopic balance legs may be included in the base without deviating from the spirit of the present invention.

As a variation, the base 180 may also include USB ports 109 and other various ports 113 for communicating electrical signals: input/output ports for audio signals, a microphone port, a DMS port, and a power input port, etc. The ports 113 may be used in place of the ports 26 (FIG. 1) mounted in the post 19 or connected to the ports 26 so that the user can use either of the ports 26 and 113. It should be apparent to those of ordinary skill that other suitable ports may be included in the base without deviating from the spirit of the present invention.

As depicted in FIG. 8, the base 100 may include a space surrounded by an upper case 101 and a lower case 114 and have components, such as weights 115 and speakers 102, in the space. The upper case 101 may include a perforated portion 119. The weights 115 may reduce the shift of the center of gravity relative to the base when the monitors pivot and/or rotate relative to the base 100, thereby to prevent the twin view system from tipping over by an inadvertent force applied thereto. A microphone may be installed in the knob 108 or installed at a suitable location in the base. Likewise, the other components, such as balance legs and weights, included in the base 100 may be disposed at suitable locations in the base without deviating from the spirit of the present invention.

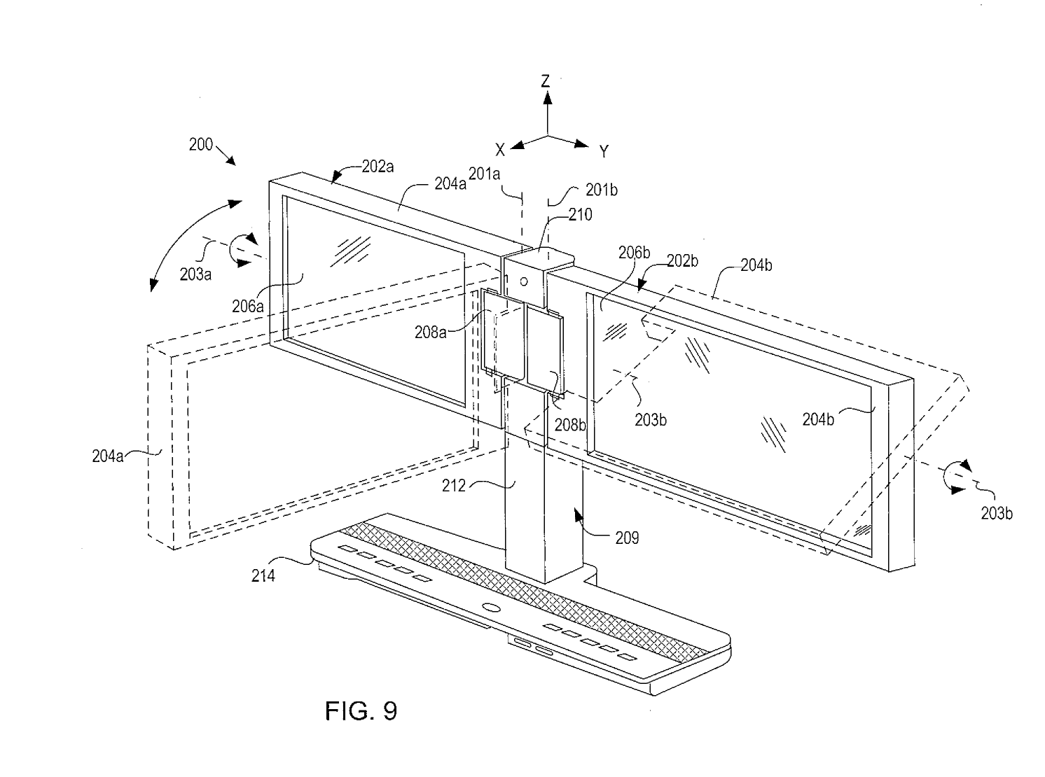

FIG. 9 shows a perspective view of a twin view system 200 in accordance with a further embodiment of the present invention. The system 200 includes: a post 209 having an upper section 210 and a lower section 212; a pair of pivot arms 208a, 208b pivotally mounted to the upper section 210 and rotatable about axes 201a, 201b; a base 214; and a pair of monitors 202a, 202b rotatably mounted to the pivot arms 208a, 208b, respectively. Each monitor may include a display screen 206a (or 206b) and a frame 204a (or 204b) for supporting the display screen.

FIG. 10A shows a schematic perspective view of the pivot arm 208b and the frame 204b of the system in FIG. 9. FIG. 10B shows another schematic perspective view of the pivot arm 208a and the frame 204a, wherein the pivot arm 208a is shown to be disengaged from the frame 204a for the purpose of illustration. As depicted, the mounting assembly 250 is similar to the assembly 60 (FIG. 5B) and used to rotatably mount the frame 204a to the pivot arm 208a so that the frame 204a can rotate about the axis 203a. The cable extending from the base may pass through the slot 245 and the hole 241 formed in the pivot arm 208a. The pivot arm 208a may include one or more ball-nosed spring plungers 243 which act as detents to define the angular span of the pivot arm 208a.

The pivot arm 208a and frame 204a include two guidance tracks 220, each track having a prominence 221 secured to the pivot arm 208a and a depression 222 secured to the frame 204a. The guidance tracks 220 may be formed of preferably, but not limited to, formed of metal and provide adequate traction between the prominence and depression so that the frame 204a can be held at the intended tilting angle around the axis 203a. The guidance tracks 220 also prevent the monitors from rotating along the x-axis (FIG. 9), thereby to relieve the mechanical load on the mounting assembly 250. As a variation, the prominence can be secured to the frame 204a while the depression can be secured to the pivot arm 208a.

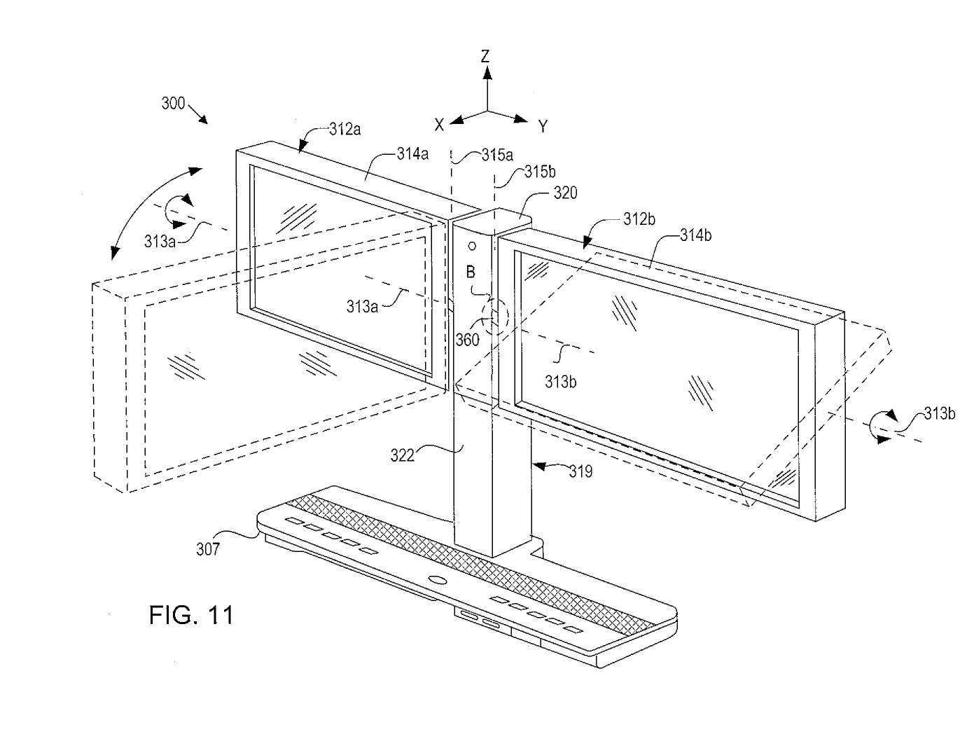

Referring to FIG. 11, there is shown at 300 a perspective view of a twin view system in accordance with another embodiment of the present invention. As depicted, the system 300 may be similar to the system 10 in FIG. 1, with the differences that the upper section 320 of the post 319 may have a generally uniform cross sectional shape along its longitudinal direction (or, equivalently z-direction) and that the monitors 312a, 312b may be rotatably mounted to the upper section 320 via mounting assemblies 360. The mounting assemblies 360 may allow each of the monitors 312a, 312b to have the dual motion relative to the post 319, i.e., the monitor 312a (or 312b) may have a pivotal motion about the axis 315a (or 315b) and a rotational motion about the axis 313a (or 313b).

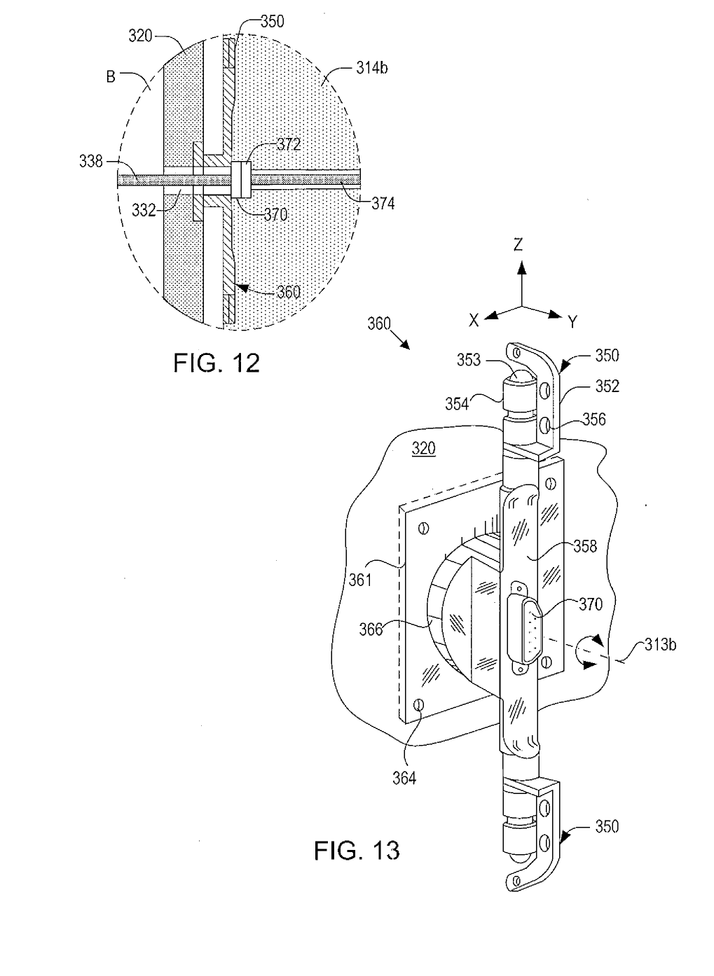

FIG. 12 shows a schematic cross sectional view of the region B in FIG. 11, taken along the y-z plane. FIG. 13 shows a schematic perspective view of the mounting assembly 360. For brevity, the frame 314b of the monitor 312b is not shown in FIG. 12. As depicted, the frame 314b may be mounted to the upper section 320 via the mounting assembly 360. The mounting assembly 360 may include an assembly base (or, shortly base) 361 secured to the upper section 320 by suitable fasteners 364 and a turret 366 rotatably coupled to the base 361 to rotate relative to the base 361 about the axis 313b. The mounting assembly 360 may also include an elongated bracket 358 having a pair of pins 353 formed at both ends thereof and a pair of hinge mechanisms 350 pivotally attached to the pins 353. Each hinge mechanism 350 may rotate relative to the bracket 358 about the z-axis and include knuckles 354 pivotally holding the pin 353 and a leaf 352 secured to the knuckles 354. The leaf 352 may have holes 356 so that suitable fasteners for securing the frame 314b to the leaf 352 can pass therethrough.

The upper section 320 may include a hole 332 through which the cable 338 extending from the upper section 320 passes. Connected to one end of the cable 338 is a male connector 370 to be engaged into a female connector 372. The female connector 372 is also connected to a cable through which electrical signals pass. The cables 338, 374 may provide power and/or various electrical signals, such as video/audio signals, to the monitor 312b.

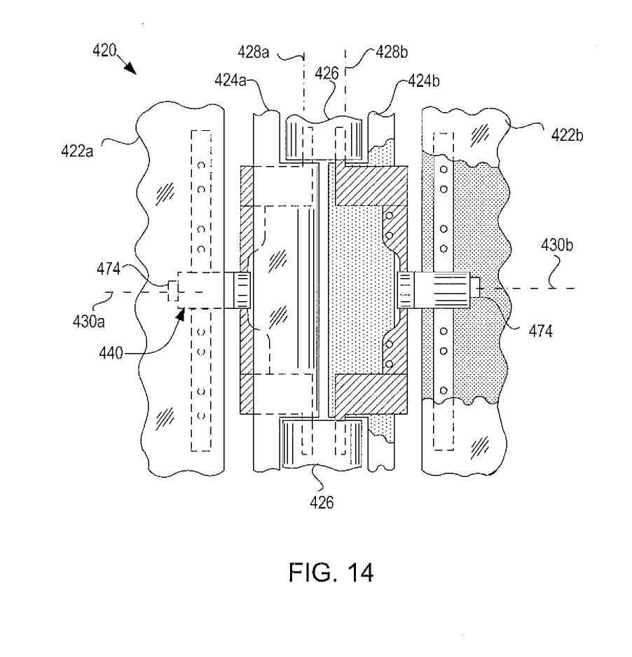

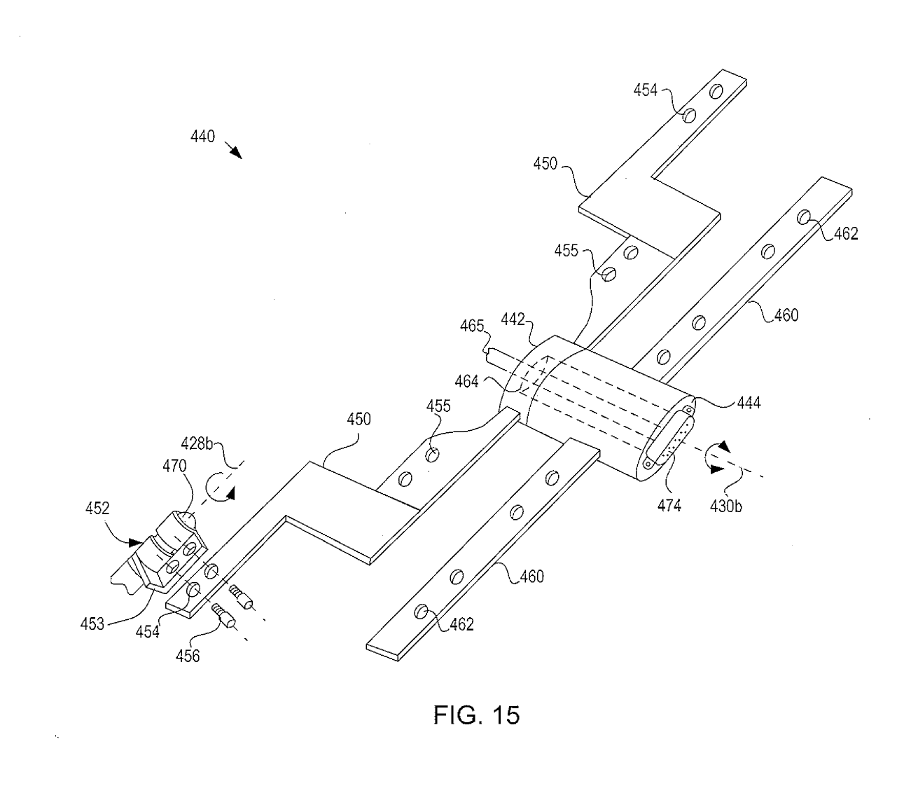

FIG. 14 is a broken partial cut away front view of an alternative embodiment of a twin view system 420 in accordance with the present invention. FIG. 15 is a perspective view of the mounting assembly 440 in FIG. 14. The system 420 is similar to the system 10 in FIG. 1, with the difference that the mounting assemblies 440 have a structure different from that of the assembly 60. As depicted, the system 420 includes: two monitors 422a and 422b; two pivot arms 424a and 424b rotatably secured to the monitors 422a and 422b, respectively; and a post 426 to which the pivot arms 424a and 424b are pivotally secured. The pivot arms 424a and 424b can respectively pivot about axes 428a and 428b passing through the pins 470 of the hinge mechanisms 452. The monitors 422a and 422b can respectively rotate about the axes 430a and 430b relative to the pivot arms 424a and 424b.

A depicted in FIG. 15, the mounting assemblies 440 includes a first cylindrical member 442 and a second cylindrical member 444 rotatably secured to the first cylindrical member. Two arms or brackets 450 have proximal ends secured to the first cylindrical member 442 and distal ends with holes 454 formed therein. Suitable fasteners 456 can be used to secure the distal ends of the brackets to two hinge mechanisms 452. More specifically, the hinge mechanism 452 includes a pin 470 secured to the post 426 and a leaf 453 to which the distal end of the bracket 450 are secured by the fasteners 456. For simplicity, only one hinge mechanism is shown in FIG. 15. However, it should be apparent to those of ordinary skill that a similar hinge mechanism may be secured to the distal end of the other bracket 450. The brackets 450 may have additional holes 455 through which fasteners for securing the brackets to the hinge arm 424b (or 424a) pass. The second cylindrical member 444 may have two arms or brackets 460 secured thereto. The brackets 460 have holes 462 through which fasteners for securing the brackets 460 to the monitor 422b (or 422a) pass.

It is noted that the first and second cylindrical members 442, 444 have a hole 464 extending the entire length of the members, i.e., the cylindrical members 442, 444 are generally hollow cylinders. A cable 465 for providing power and/or various electrical signals, such as video/audio and microphone signals, to the monitor 422b may pass through the hole 464 formed in the cylindrical members 442, 444.

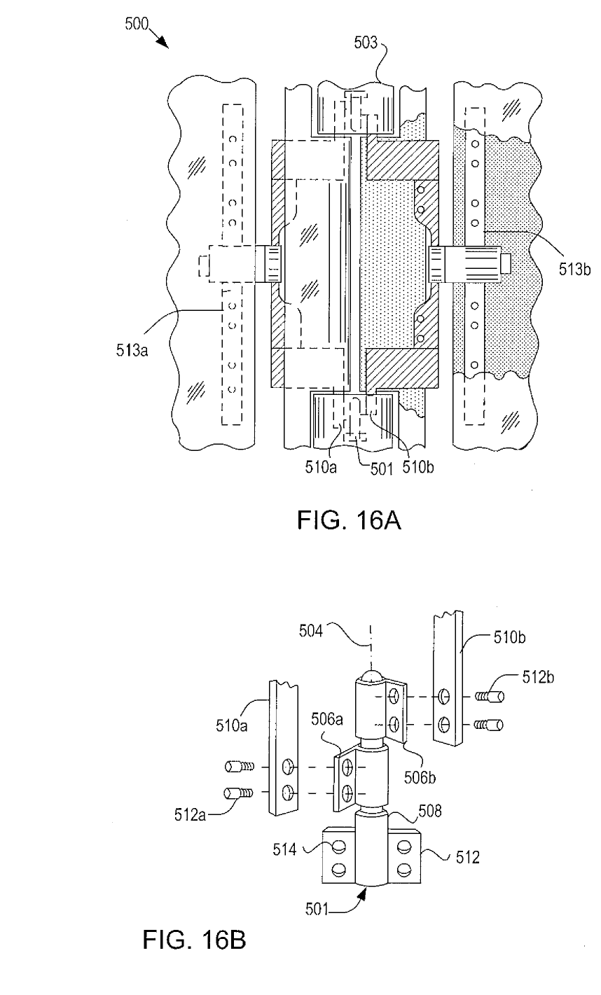

FIG. 16A is a broken partial cut away front view of an alternative embodiment of a twin view system 500 in accordance with the present invention. FIG. 16B is an exploded view of an embodiment of a hinge mechanism 501 in the system 500 of FIG. 16A. As depicted, the system 500 is similar to the system 420 of FIG. 14, with the difference that the two mounting assemblies 513a, 513b are pivotally secured to the hinge mechanism 501. More specifically, the tips of flanges 510a, 510b are secured to the leaves 506a, 506 by fasteners 512a, 512b such that the mounting assemblies 513a, 513b can pivot about the axis 504. Secured to the base 508 of the hinge mechanism 501 are wings 512 that are affixed to the post 503.

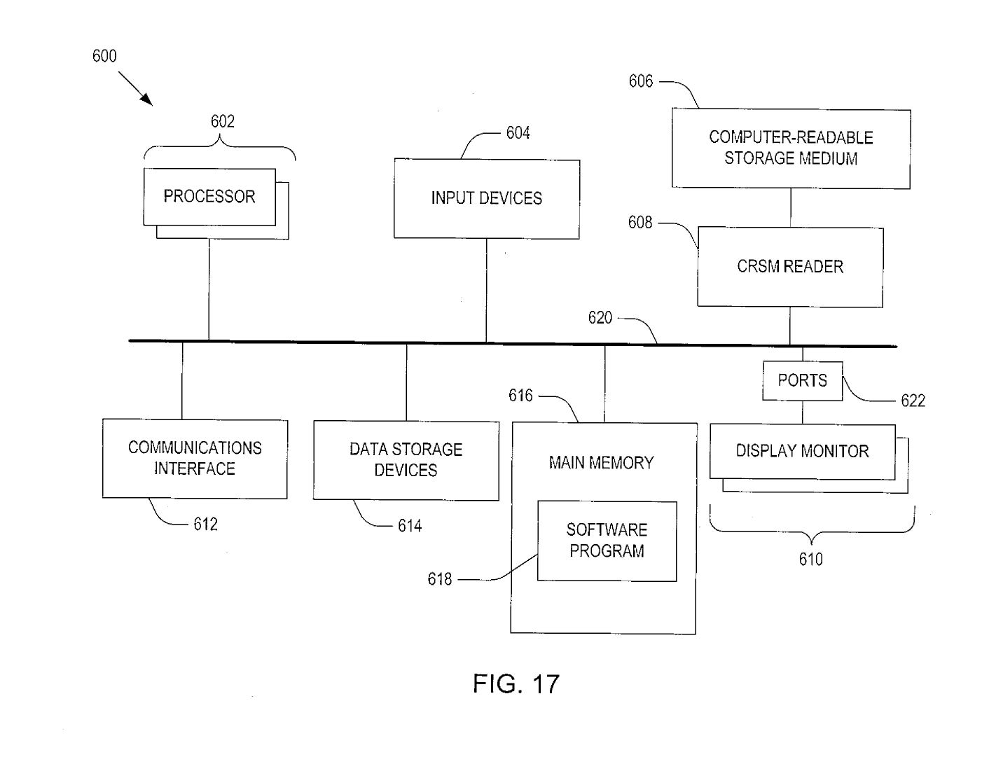

FIG. 17 shows a computer 600 of a type that might be employed in accordance with the present invention. In one embodiment, the monitors 610 may be separated from the other components of the computer 600 and connected to the other components through the ports 622 that may correspond to the ports 26 (FIG. 1). As discussed above, the ports 622 may include wireless communication ports, such as RF or IR port, as well as hard-wired connection ports. The computer 600 of FIG. 17 may have less or more components to meet the needs of a particular application. As shown in FIG. 17, the computer may include one or more processors 602 including CPUs and GPUs. The computer may have one or more buses 620 coupling its various components. The computer may also include one or more input devices 604 (e.g., keyboard, mouse, joystick), a computer-readable storage medium (CRSM) 606, a CRSM reader 608 (e.g., floppy drive, CD-ROM drive), a communication interface 612 (e.g., network adapter, modem) for coupling to a network, one or more data storage devices 614 (e.g., hard disk drive, optical drive, FLASH memory), and a main memory 616 (e.g., RAM). Software embodiments 618 may be stored in a computer-readable storage medium 606 for reading into a data storage device 614 or main memory 616.

In some embodiments, one of the monitors of FIGS. 1, 9, 1, 14, and 16 may include a computer 600 and the twin view system may be used as a portable computer. For instance, the monitors 12a and 12b, pivot arms 18a and 18b, and the upper section 20 of the post 19 (FIG. 1) can be carried as a portable computer unit. In alternative embodiments, the posts in FIGS. 1, 9, 1, 14, and 16 may have other configurations. The detailed description of the various embodiments of the post can be found in U.S. patent application Ser. No. ______, entitled “Systems having twin display monitors” by Han, filed on Dec. ______, 2007, which is herein incorporated by reference in its entirety.

It is noted that each monitor and/or post may include at least one attitude sensor that can sense the attitude of the monitor. When the monitor is rotated about an axis, say 13b (FIG. 1), by 180 degrees, the displayed image should be also rotated by 180 degrees. Likewise, when the monitor is switched from portrait to landscape mode, or vise versa, the displayed image should be rotated by 90 degrees. Upon sensing the attitude of the monitor, the sensor may send a signal to a computer so that the images transmitted from the computer and displayed on the monitor can be properly rotated. As a variation, a suitable control mechanism, such as a button, can be installed on the twin display system, allowing a user to rotate the image manually.

Notwithstanding that the present invention has been described above in terms of several alternative embodiments, it is anticipated that still other alterations and modifications will become apparent to those of ordinary skilled in the art after having read this disclosure. It is therefore intended that such disclosure be considered illustrative and not limiting, and that the appended claims be interpreted to include all such alterations, modifications and embodiments as fall within the true spirit and scope of the invention.

What is claimed is:

1. A system for displaying a plurality of images, comprising:
a hollow post adapted for connection to a support means and having a recessed portion;
a pair of pivot arms including mounting protrusions pivotally mounted in said recessed portion, each said pivot arm being adapted to pivot about a first axis substantially parallel to a longitudinal axis of said hollow post;
a pair of mounting assemblies respectively affixed to said pivot arms, each said mounting assembly including a first signal connector; and
a pair of monitor frames respectively secured to said mounting assemblies, each said monitor frame including two second signal connectors configured to respectively engage said first signal connector at portrait and landscape orientations thereof relative to said post,
wherein each said mounting assembly is adapted to allow one of said monitor frames to rotate relative to said post about a second axis substantially perpendicular to said first axis.

2. A system as recited in claim 1, wherein each said mounting assembly includes:
an assembly base affixed to one of said pivot arms;
a turret mounted to said assembly base and rotatable about said second axis relative to said assembly base; and
an elongated bracket affixed to said turret and one of said monitor frames, said first signal connector being affixed to said elongated bracket.

3. A system as recited in claim 1, wherein said hollow post includes a plurality of pivot rods extending into said recessed portion along said first axis and said pivot arms include a plurality of cavities for receiving said pivot rods.

4. A system as recited in claim 1, wherein each said pivot arm includes a plurality of pivot rods extending along said first axis and said hollow post includes a plurality of holes for receiving said pivot rods.

5. A system as recited in claim 1, further comprising:
two pairs of hinge mechanisms affixed to said hollow post, each said pair of hinge mechanisms arranged substantially along said first axis,
wherein each said mounting assembly includes:
a first hollow cylindrical member;
a pair of first brackets, each said first bracket having a proximal end secured to said first hollow cylindrical member and a distal end rotatably secured to one of said pairs of hinge mechanisms;
a second hollow cylindrical member rotatably secured to said first hollow cylindrical member and rotatable about said second axis relative to said first hollow cylindrical member, said first signal connector being affixed to said second hollow cylindrical member; and
a pair of second brackets, each said second bracket being secured to said second hollow cylindrical member and to one of said monitor frames.

6. A system as recited in claim 1, wherein each said pivot arm includes one or more ball-nosed spring plungers and said hollow post includes one or more mating cavities for receiving balls of said plungers, whereby said plungers and said balls form one or more detent mechanisms.

7. A system as recite in claim 1, further comprising a camera mounted in a wall of said hollow post.

8. A system as recited in claim 1, wherein said support means includes:
an other hollow post having a first and a second end, said first end being secured to said hollow post; and
a base secured to said second end.

9. A system as recited in claim 8, further comprising:
one or more communication ports disposed in a wall of said other hollow post; and
one or more cables running through said hollow post and said other hollow post to connect said communication ports to said first connector.

10. A system as recited in claim 8, wherein said base includes a balance mechanism for preventing said system from tipping over, said balance system having one or more of the group consisting of a balance leg hinged at one end thereof to said base, a telescopic balance leg, and at least one weight.

11. A system as recited in claim 8, wherein said base includes one or more of the group consisting of a microphone, control buttons for setting display parameters of monitors, speakers, and a wireless signal receiver for receiving communication signals.

12. A system as recited in claim 1, wherein one of said monitor frames includes a computer.

13. A system as recited in claim 1, further comprising two guidance track mechanisms, each said guidance track mechanism including a depression formed one of said pivot arms and a prominence formed on a corresponding one of said monitor frames and configured to slidably engage said depression to thereby relieve mechanical load on a corresponding one of said mounting assemblies.

14. A system for displaying a plurality of images, comprising:
a hollow post adapted for connection to a support means;
a pair of mounting assemblies affixed to said hollow post, each said mounting assembly including a first signal connector; and
a pair of monitor frames respectively secured to said mounting assemblies, each said monitor frame including two second signal connectors configured to respectively engage said first signal connector at portrait and landscape orientations thereof relative to said post,
wherein each said mounting assembly is adapted to allow a monitor to pivot about a first axis substantially parallel to the longitudinal axis of said hollow post and to rotate about a second axis substantially perpendicular to said first axis.

15. A system as recited in claim 14, wherein each said mounting assembly includes:
an assembly base affixed to said hollow post;
a turret rotatably mounted to said assembly base;
an elongated bracket secured to said turret, said first signal connector being affixed to said elongated bracket; and
a pair of hinge mechanisms pivotally attached to both ends of said bracket, one of said monitor frames being affixed to said hinge mechanisms.

16. A system as recited in claim 14, wherein said support means includes:
an other hollow post having a first and a second end, said first end being secured to said hollow post; and
a base secured to said second end.

17. A system as recited in claim 16, further comprising:
one or more communication ports disposed in a wall of said other hollow post; and
one or more cables running through said hollow post and said other hollow post to connect said communication ports to said first connector.

18. A system as recited in claim 16, wherein said base includes a balance mechanism for preventing said system from tipping over due to an external force applied thereto, said balance system having one or more of the group consisting of a balance leg hinged at one end thereof to said base, a telescopic balance leg, and at least one weights.

19. A system as recited in claim 16, wherein said base includes one or more of the group consisting of a microphone, control buttons for setting display parameters of monitors, speakers, and a wireless signal receiver for receiving communication signals.
